(19) United States
(12) Patent Application Publication
(10) Pub. No.: US 2004/0034635 A1
(43) Pub. Date: Feb. 19, 2004

(54) Method and system for identifying and matching companies to business event information

(76) Inventors: David Anthony Czarnecki, Clifton Park, NY (US); Corey Nicholas Bufi, Troy, NY (US); Melvin Kurt Simmons, Schenectady, NY (US); Richard Martin Spackmann, Saratoga Springs, NY (US)

Correspondence Address: General Electric Company, CRD Patent Docket Rm 4A59, Bldg. K-1, P.O. Box 8, Schenectady, NY, 12301, US

(21) Appl. No.: 10/336,545

(22) Filed: Jan. 6, 2003

Related U.S. Application Data
(63) Continuation-in-part of application No. 10/218,620, filed on Aug. 15, 2002.

(51) Int. Cl. G06F 7/00

(52) U.S. Cl. 707/7

(57) ABSTRACT

The present invention provides a system, method and computer program product for identifying and matching company names to business event information. A crawler crawls and downloads documents by starting from a pre-defined set of links. A parser breaks down the downloaded documents into components like text, titles and links. An evaluator evaluates the parsed documents and selects documents on the basis of amount of relevant information contained in the documents. An information extractor identifies the occurrences of company names in the text contained in the selected documents. It also identifies occurrences of business events, specified by a pre-defined set of event phrases, in the text contained in the selected documents. Further, the information extractor matches the identified company names to the identified business events in order to generate company-business event pairs.

### CROSS REFERENCE TO RELATED APPLICATIONS

This application is a continuation-in-part of application Ser. No. 10/218,620, entitled “Method And System For Event Phrase Identification,” assigned to General Electric Capital Corporation, filed on Aug. 15, 2002, which is hereby incorporated by reference.

### BACKGROUND OF THE INVENTION

The present invention relates to automated information retrieval. More specifically, the present invention relates to a method and system for identifying and matching company names to related business events, the company names and business events being available in textual sources of information.

In the present age of information and technology, business enterprises spend a significant proportion of their time and monetary resources in locating business related information on the World Wide Web (WWW). This business related information is then analyzed to derive inferences, which may prove useful to the business enterprises. However, with the tremendous growth in the amount of information on the WWW over the recent years, it is becoming increasingly difficult for the business enterprises to find the business related information they are looking for. Moreover, the business related information may exist in different formats among heterogeneous information sources on the WWW.

The business related information sought by the enterprises typically comprises information like user profiles, competitor data and business event information. The business event information is the information pertaining to business events. Events like “initial public offering”, “job cuts”, “product launch”, “bankruptcy filing” are some examples of business events that constitute business event which they can be associated. In general, business events and company names are found in information sources like news stories on the WWW. The matching of business events to the associated company names that exist in the information sources constitutes the business event information.

Gathering business event information on the WWW involves two major problems. First, it is difficult to identify, with a good degree of accuracy, information sources on the WWW containing information on the desired business events. Secondly, even if the information sources containing information on the desired business events are identified, it is a time consuming job to manually extract the desired business event information from these information sources.

The existing techniques fail to appreciate and efficiently address the above-mentioned problems. Hence, there exists a need for a method and system, which can automatically identify information sources containing the relevant business event information on the WWW and extract this information. The system should be capable of automatically identifying company names and the desired business events present in the text contained in the information sources. Further, it should be capable of matching the business events to the company names found in the text in order to extract the business event information.

### BRIEF SUMMARY OF THE INVENTION

In accordance with one aspect, the present invention provides a system, which comprises a processing device, an input device and an output device. The processing device further comprises a crawler, a parser, an evaluator, and an information extractor. The processing device also comprises a memory element and a storage device. The crawler crawls through the documents that are referenced by a user-defined first set of links and downloads the documents referenced by the links. The downloaded documents are then passed on to the parser, which breaks down the downloaded documents into components like text, titles and a second set of links contained in the downloaded document. The parsed documents are then passed on to the evaluator, which estimates the amount of relevant information contained in the parsed documents. The evaluator further selects documents for further processing on the basis of amount of relevant information contained in them. The selected documents are processed by the information extractor, which identifies occurrences of company names and business events in text contained in the selected documents. Further, the information extractor matches the identified company names to the identified business events in order to generate company-business event pairs.

In accordance with another aspect, the present invention also provides a method for identifying company names and business events in a text, and further matching the identified company names to the identified business events in order to generate company-business event pairs. The method comprises the steps of crawling through the documents by starting from a pre-defined first set of links. The documents referenced by the links contained in the first set of links are downloaded during crawling. The downloaded documents are parsed and broken down into individual components like text, titles and links occurring in the downloaded documents. The parsed documents are then evaluated to assign a score to each parsed document on the basis of the amount of relevant information contained in the document. Documents are selected for further processing on the basis of the score assigned to the documents. The selected documents are then processed to identify the occurrences of company names and business events in the text contained in the selected documents. The identified company names are then matched to the identified business events in order to generate company-business event pairs.

In accordance with another aspect, the present invention provides a computer program product embodied on a computer readable means for identifying company names and business events in a text, and further matching the identified company names to the identified business events in order to generate company-business event pairs. The computer program code comprises the steps of crawling the network and downloading documents, parsing the downloaded documents, evaluating the parsed documents to select documents on the basis of a score, identifying the company names and business events contained in the documents, and matching the identified company names to the identified business events in order to generate company-business event pairs.

### BRIEF DESCRIPTION OF THE DRAWINGS

The various embodiments of the present invention will hereinafter be described in conjunction with the appended drawings provided to illustrate and not to limit the present invention, wherein like designations denote like elements, and in which:

FIG. 1 is a block diagram showing the general working environment of one embodiment of a system 100 for identifying and matching company names to business event information.

FIG. 2 is a block diagram that illustrates the flow of information between the different modules, in accordance with one embodiment of the present invention;

FIGS. 3A and 3B illustrate a flowchart outlining the steps involved in the process of identifying and matching company names to business event information, in accordance with one embodiment of the present invention;

FIG. 4 is a flowchart that illustrates the method of identifying occurrences of company names in text in further detail, in accordance with one embodiment of the present invention;

FIG. 5 is a flowchart that illustrates the method of identifying occurrences of business events in text in further detail, in accordance with one embodiment of the present invention; and

FIGS. 6A and 6B illustrate a flowchart outlining the steps involved in matching identified company names to identified business events in further detail, in accordance with one embodiment of the present invention.

### DETAILED DESCRIPTION OF THE INVENTION

The present invention is a system and method for identifying and matching company names to business event information. The present invention identifies occurrences of company names and business events in a text, and matches the identified company names to the identified business events in order to generate company-business event pairs.

Business event information is the information pertaining to business events. Some examples of business events include events like “initial public offering”, “product launch”, “job cuts”, “bankruptcy filings” and other similar events that can be associated with companies. Business event information can be found in information sources. In general, information sources comprise electronic documents in one or more file formats and include text containing the desired company name and/or business event information. For example, web pages containing news stories related to business events constitute information sources for identifying business event information. The information sources may be present in the form of a local database or on a network. In either case, the location of an information source can be specified by a link that provides a reference to the location of the information source in the local database, or in the network.

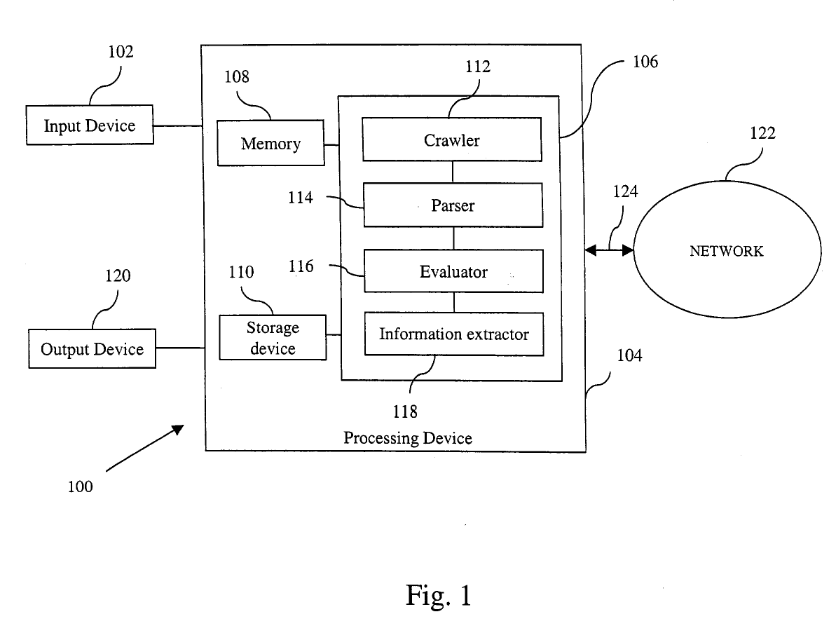

FIG. 1 is a block diagram showing the general working environment of one embodiment of a system 100 for identifying and matching company names to business event information. The present invention uses a pre-defined first set of links to documents and a pre-defined set of event phrases for identifying business events. The present invention then searches the documents for identifying occurrences of business events and company names. Subsequently, the company names are matched to the business events in order to generate company-business event pairs. The pre-defined set of links can either be specified by the user using input device 102 or may be available through the use of processing device 104. Similarly, the pre-defined set of event phrases for identifying the business events can either be specified by the user using input device 102, or may be available through the use of processing device 104. Input device 102 can be a device like a keyboard or a signal processing system that processes signals received from the user and converts them into event phrases or links.

Processing device 104 consists of a processing portion 106, a memory element 108 and a storage device 110. Processing portion 106 further comprises four modules. The modules are a crawler 112, a parser 114, an evaluator 116 and an information extractor 118.

Crawler 112 includes a program that fetches documents, such as web pages, and downloads the documents. Crawler 112 may initiate the fetching process by starting from the first set of links. Parser 114 breaks down the downloaded documents into individual components. Evaluator 116 evaluates the parsed documents and selects the documents that contain relevant information for further processing. Information extractor 118 processes the selected documents to identify and match business events to company names that occur in the selected documents. The output is then passed to an output device 120 that is connected to the processing device. The output device can be a device like a monitor for displaying the output to the user, or it can be a database in which the output is stored.

Processing Device 106 is connected to a network 122 through a communication link 124. Communication link 124 is an interconnection that facilitates the transfer of information between processing device 106 and network 122. Communication link 124 can be a link such as a telephone, cable or a satellite link. Network 122 can be a public communications network, a private communications network, a Local Area Network (LAN), a Wide Area Network (WAN) or the World Wide Web (WWW).

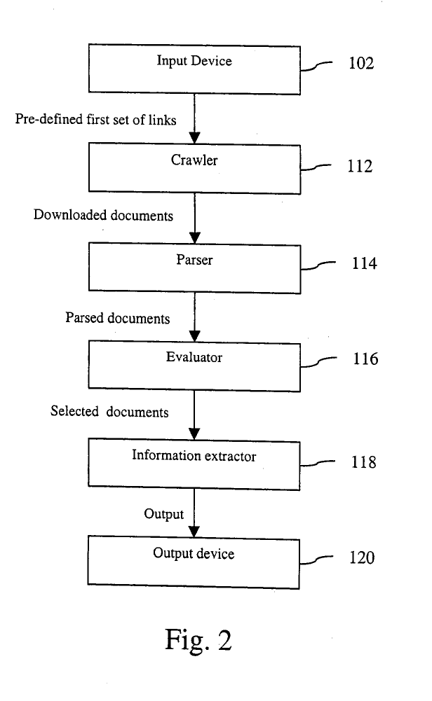

FIG. 2 is a block diagram that illustrates the flow of information between the different modules of the present invention. The user can input the first set of links and the set of event phrases for identifying business events through input device 102. Crawler 112 uses the first set of links to identify a set of documents from which it should start crawling. Crawler 112 downloads the documents referenced by the links present in the first set of links. These downloaded documents are then passed onto parser 114, which breaks down the documents into individual components or recognizable strings of information. The individual components are different parts of the document like free text, title, image and links that make up a document. For example, a downloaded web page will be broken down by parser 114 into components like title, free text, and a second set of links. The links in this case will be the hyperlinks that point to other web pages or documents on the World Wide Web.

The parsed documents are then passed to evaluator 116, which evaluates the documents to estimate the amount of relevant information contained in the documents. Evaluator 116 further selects the documents that contain relevant information for further processing by information extractor 118.

Information extractor 118 identifies occurrences of business events in a text contained in the selected documents using the pre-defined set of event phrases. It further identifies occurrences of company names in the text contained in the selected documents. After identifying the business events and the company names occurring in the document, information extractor 118 matches the business events to the appropriate company names in order to generate company-business event pairs. The company-business event pairs are then passed on to output device 120.

In one embodiment of the present invention, processing device 104 is connected to the World Wide Web. A user-defined first set of links and a user-defined set of event phrases are received as input through input device 102. Crawler 112 performs the function of crawling through web pages on the World Wide Web and downloading each web page that it visits. Parser 114 performs the function of breaking down the downloaded web pages into components comprising title, free text and a second set of hyperlinks contained in the web page.

Evaluator 116 assigns an information quantity score to each parsed web page. The information quantity score is a measure of the amount of relevant information that may be contained in the parsed web page. The amount of relevant information implies the potential amount of business event information that may be contained in a document. The web pages having a score above a pre-defined threshold score are then selected for further processing. The pre-defined threshold score value can also be a user-specified value provided to processing device 106 through input device 102. Further, information extractor 118 identifies and matches company names to business events occurring in the text contained in each selected web page.

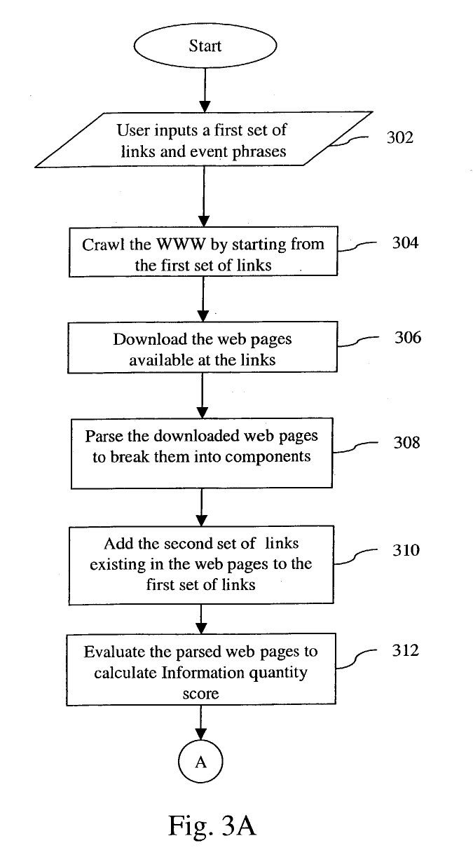

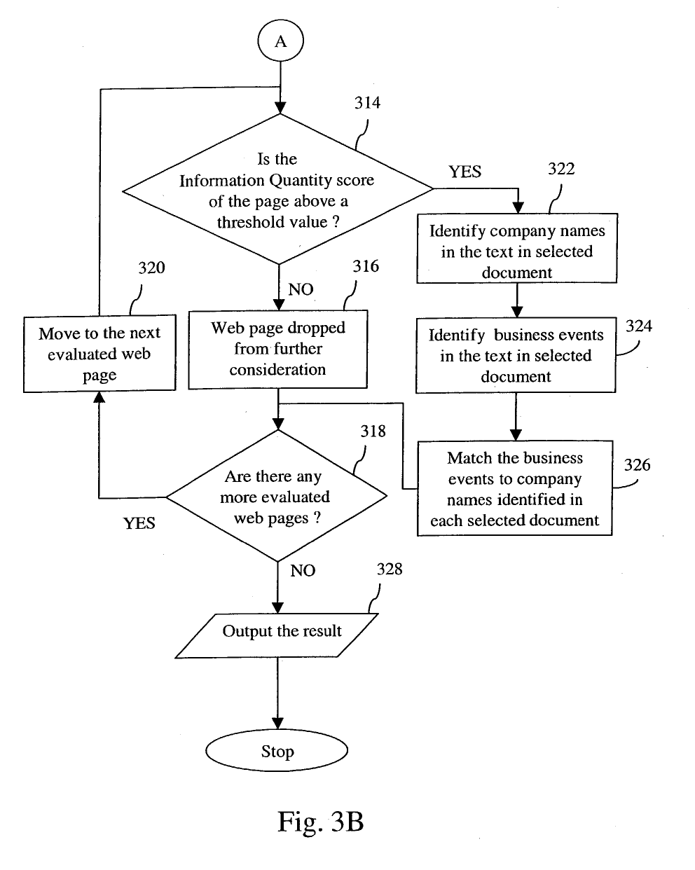

FIGS. 3A and 3B illustrate a flowchart outlining the steps involved in the process of identifying and matching company names to business event information, in accordance with one embodiment of the present invention.

At step 302, the user inputs a first set of links and a set of event phrases. The first set of links comprises user-specified hyperlinks to web pages on the World Wide Web. The set of event phrases input by the user includes phrases that are used to identify business events occurring in the text contained in the web pages. For example, if the user is interested in business events that are related to “job cuts”, then the user may input a set of event phrases comprising phrases like “job cuts” or “retrenchment” or “lay offs” or other similar phrases that can be used to identify the business events related to job cuts.

At step 304, the web pages corresponding to the first set of links specified by the user are crawled and at step 306, all the web pages visited during crawling are downloaded. Subsequently at step 308, the downloaded web pages are parsed and are broken down into individual components. The downloaded web pages are broken down into components like free text, title, and hyperlinks corresponding to other web pages on the World Wide Web. The hyperlinks found in the parsed web pages comprise a second set of links. The second set of links comprising the hyperlinks identified in the parsed web pages is then added to the user-defined first set of links as shown at step 310.

The parsed web pages are then evaluated at step 312 to calculate an information quantity score for each parsed web page. The information quantity score is indicative of the potential amount of business event information that can be found in the web page. The information quantity score is calculated as a ratio of free text contained in the page to the total page size. A high information quantity score value indicates that the web page has a high potential of containing business event information.

The information quantity score of each parsed web page is then compared with the pre-defined threshold score value at step 314. If the information quantity score of the parsed web page is less than the threshold score value, then step 316 is performed in which the web page is dropped from any further consideration and is not processed further. At step 318, if there are any more evaluated web pages, then the next web page is taken up for consideration at step 320.

However, as checked at step 314, if the information quantity score of the web page is greater than the threshold value, then the web page is selected for further processing and step 322 is performed. At step 322, the occurrences of company names in the text contained in the selected web page are identified. This step involves identifying the occurrences of company names in the text contained in the selected web page.

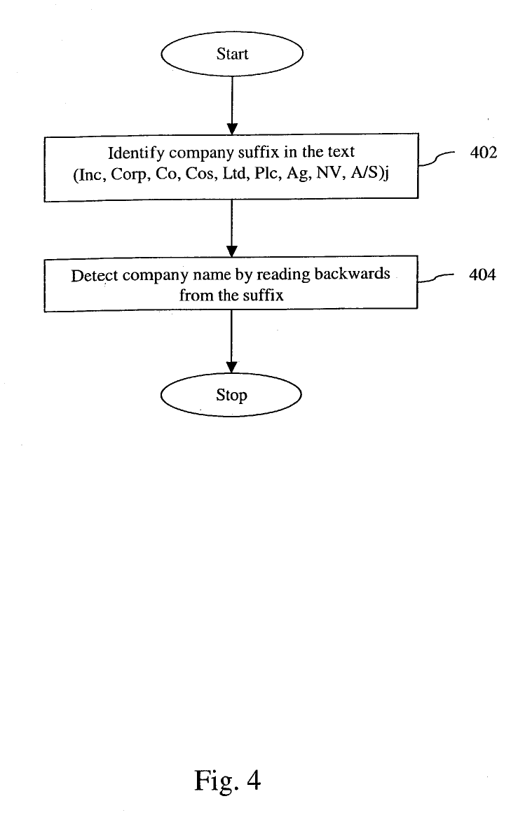

FIG. 4 is a flowchart that illustrates the method of identifying occurrences of company names in text in further detail, in accordance with one embodiment of the present invention.

At step 402, occurrences of pre-defined company name suffixes in the text contained in the selected web page are identified. Company name suffixes include suffixes like Corp, Co, Cos, Ltd and others that qualify as indicators of the presence and location of company names in text contained in the selected web page.

At step 404, the company names are identified using a set of heuristics and stop conditions by reading backwards from the company name suffix. An illustration of one embodiment of a process of identifying company names by identifying company name suffixes in a text is mentioned in U.S. Pat. No. 5,287,278 titled “Method For Company Names From Text” and hereby incorporated by reference. This patent explains a method for identifying company names by identifying the company name suffixes and then reading backwards from the identified suffixes in the text, till one of the pre-defined stop conditions is met. The words, which are identified while reading backwards from the company name suffix in the text, are then identified as the company name.

The illustration provided in the above-cited patent is just one example of a method for identifying company names in a text, and other methods for identifying occurrences of company names in a text may be utilized.

For instance, in another embodiment, co-references of company names are along identified along with the company names in order to augment the identification of occurrences of company names in the text. Co-references are substitutes that are used to refer to company names in different parts of the text. For example, terms like “the company” and “it” may often be used in text to refer to specific company names. Such terms are co-references of the company names, which they refer to. For example, in one embodiment, the system and method of the present invention may identify a company name based on the identification of a company suffix, and also identify co-references of the company name in the text following the company name and associate the co-references with the company name. Once the co-references of company names are identified in the text, the co-references can be matched to appropriate business events, which they correspond to. This can be used to augment the capability of the present invention to extract company-business event pairs from the information contained in a text.

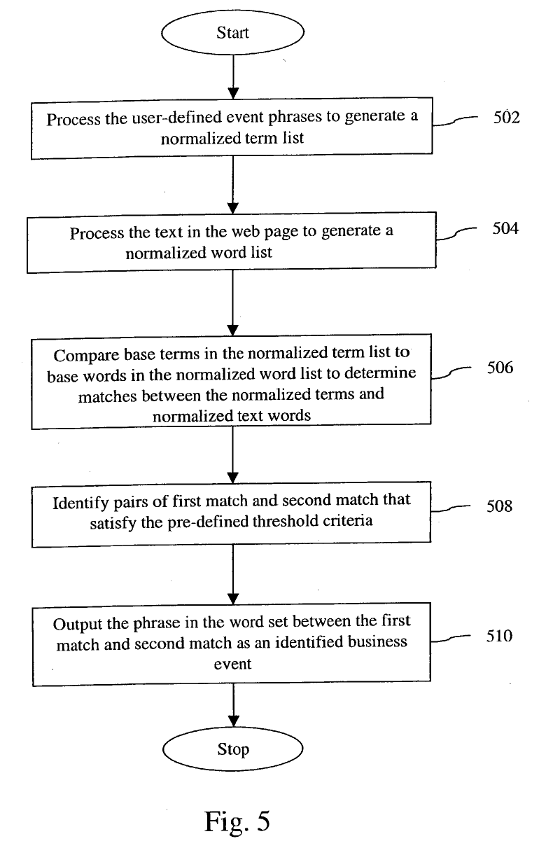

Step 324 of FIG. 3B involves identifying the occurrences of business events in the text contained in the selected web page. In this step, business events are identified by matching words in the text contained in the selected web page with words contained in the user-defined set of event phrases. FIG. 5 is a flowchart that illustrates the step of identifying occurrences of business events in text in further detail in accordance with one embodiment of the present invention.

At step 502, the user-defined event phrases are processed to generate a normalized term list. The normalized term list is a list comprising base words corresponding to terms contained in the user-defined set of event phrases. A base word is a word, which can be modified to generate different variations of the word. For example, variations of the word “replace” like “replacing”, “replaces” and “replaced” have the same base word “replace”. So, when any of above-mentioned variations occur in an event phrase in the user-defined set of event phrases, the variations are replaced by the base word “replace” while preparing the normalized list.

At step 504, the text contained in the selected web page is processed to generate a normalized word list. The normalized word list is a list comprising base words corresponding to words in the text contained in the selected web page. For the purpose of clarity, it is useful to remember that the normalized term list corresponds to the user-defined set of event phrases and the normalized word list corresponds to the text contained in the selected web page.

At step 506, the terms in the normalized term list and the words in the normalized word list are compared to determine matches between the normalized terms and the normalized words. Step 506 further involves determining a first match between a normalized term and a normalized word and a second match between another normalized term and another normalized word.

At step 508, pairs of first match and second match that satisfy a set of pre-defined threshold criteria are identified. A pair of first and second match satisfies the set of pre-defined threshold criteria when the distance between the first match and second match in the text lies within a pre-defined maximum distance value.

At step 510, for each of the pairs of first and second matches, which satisfy the threshold criteria, the phrase between the first match and the second match, which constitute a match, is identified as a business event for each pair. In this step, pairs of first match and second match that satisfy the threshold criteria are selected. The phrase occurring between the first match and second match for each such pair is then identified as a business event.

In this manner, business events are identified in a precise, as well as in a linguistic, manner. Precise identification of business events means that occurrences of business events are identified in the text by searching for terms in the same order as they are specified in the user-defined set of event phrases. Linguistic identification of business events implies that occurrences of business events are identified in the text by searching the text for variations of the terms contained in the user-defined set of event phrases, such as a variation in the order of the terms, a variation in the relative spacing between the terms, and any variation in the spellings or case of the terms.

An illustration of the above-described method for identifying occurrences of business events in text contained in the selected web page is provided in U.S. patent application Ser. No. 10/218,620 titled “Method And System For Event Phrase Identification”, hereby incorporated by reference.

The illustration provided in the above-cited patent application is just one example of a method for identifying business events in a text, and other methods for identifying occurrences of business events in a text may be utilized.

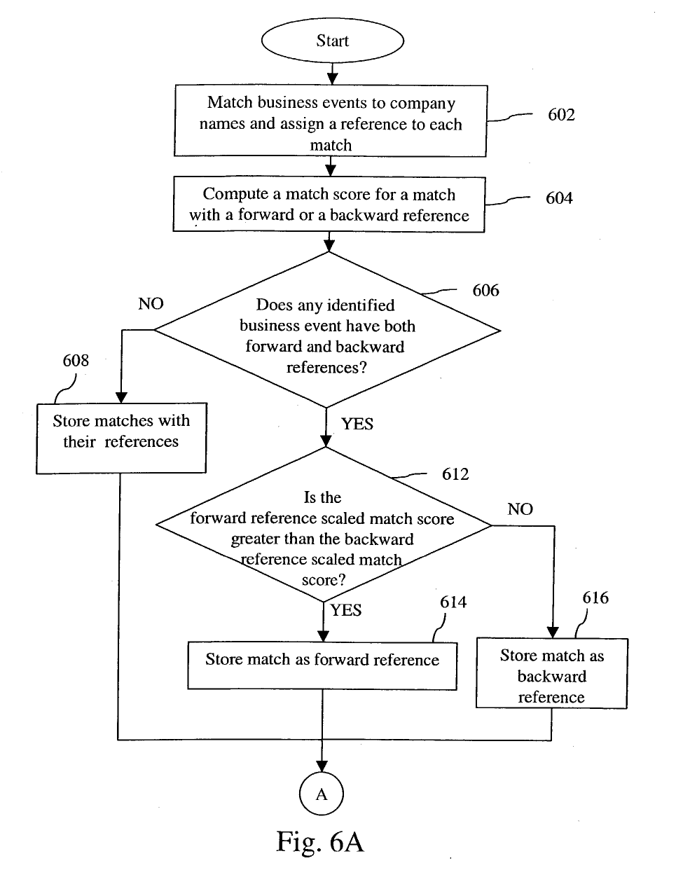

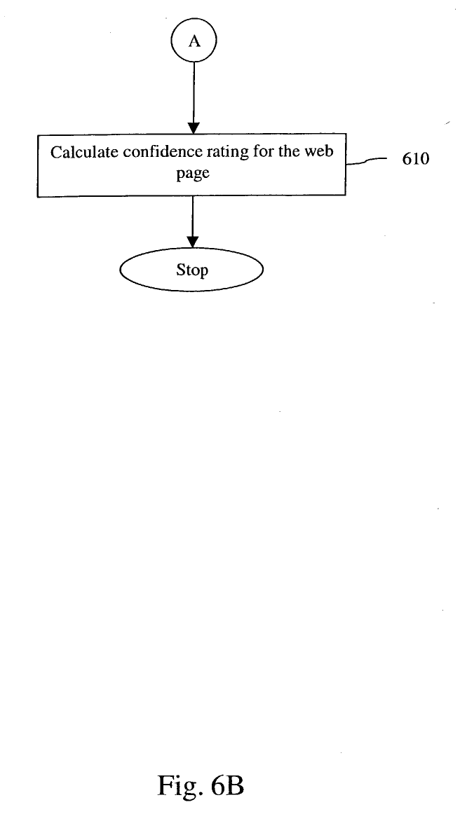

Step 326 of FIG. 3B involves matching the business events identified in step 324 to the company names identified in step 322. Matching business events to company names involves identifying the relationship between the company names and business events identified in the selected web page and further generating company-business event pairs on the basis of these relationships. FIGS. 6A and 6B illustrate a flowchart outlining the steps involved in matching identified company names to identified business events in further detail in accordance with one embodiment of the present invention.

At step 602, a match between the business events and company names is generated and a reference is assigned to each match. There can be three kinds of matches that may exist between business events and company names. These matches are a backward reference, a forward reference and a non-match called an orphan event or reference. In a backward reference, the event occurs after a company name in the text. The reference from the event to the company name is backward. Hence, this kind of a reference is known as a backward reference. In a forward reference, the event occurs before the company name in the text. The reference from the event to the company name is forward. Hence, this kind of a match is termed a forward reference. An orphan event or reference occurs when a business event is not matched to any company name.

The following examples illustrate the difference between a forward and a backward reference. The sentence given below presents an example of a backward reference between a business event and a company name.

“Bethlehem Steel Corporation, a titan of the steel industry, filed for bankruptcy in the state of Pennsylvania.”

In the above sentence, the company name is Bethlehem Steel Corporation and the business event is “filed for bankruptcy”. Since the business event occurs after the company name, the reference for the match between Bethlehem Steel Corporation and “filed for bankruptcy” in the above sentence is backwards.

On the other hand, the sentence given below presents an example of a forward reference.

“The bankruptcy filing of the Bethlehem Steel Corporation shows that the steel industry is in for tough times”.

In the above sentence, the company name is Bethlehem Steel Corporation and the business event is “bankruptcy filing”. In this case, the business event occurs before the company name and hence the reference for the match between the business event and company name is forward.

A match having a forward reference or a backward reference is called a positive match. There may also be matches, which have both a forward reference as well as a backward reference associated with them. As will be discussed below with regard to steps 612, 613 and 614, a match having a forward as well as a backward reference is eventually characterized as a forward reference or a backward reference based on predetermined characteristics of the match.

At step 604, a match score ‘m’ is computed for each match with a forward or a backward reference on the basis of the distance that exists between the company name and the business event that constitute a match. In one embodiment of the present invention, the match score value is calculated as a ratio of a distance between the company name and business event to a total sentence length. Mathematically, it can be represented as:

Match score value assigned to a match=m=(Distance between company name and business event)/Total sentence length

According to this method for computing the value of ‘m’, the matches in which the company name is closer to the business event are assigned a lower match score value. Such matches are called strong matches. The matches with a large distance between the business event and the company name are assigned a higher match score value. Such matches are called weak matches. Further, the match score for each match may be scaled. In one embodiment of the present invention, each match is assigned a match score ‘m’ between 0 and 1, and the scaled match score value is calculated by subtracting match score ‘m’ from one. Hence, stronger matches have a scaled match score value closer to one while the weaker matches have scaled match score values closer to zero. Mathematically, it can be expressed as:

Scaled match score value for a match=(1−m)

This is followed by step 606, at which business events are checked to determine if the match corresponding to any business event has both forward and backward references. If any such business event does not exist, then step 608 is performed. At step 608, the matches corresponding to the selected web page are stored along with their references.

Finally, at step 610, a confidence rating for the selected web page is calculated. The confidence rating for the selected web page is based on the contribution from events classified as forward or backward references, and the contribution from the events classified as orphan references. Numerous schemes may be utilized to determine a confidence rating. For example, in one embodiment of the present invention, a confidence rating scheme conveys a greater degree of confidence in a web page that has a large number of strong matches as compared to a web page with a relatively larger number of weak matches.

However, as checked at step 606, if a business event exists which has both forward and backward references, then step 612 is performed. At step 612, scaled match scores are compared for the forward and backward references corresponding to the business event that has both forward and backward references. It is useful to remember that at step 612, it is the scaled match score value assigned to each match that is being compared and not the match score value. If the scaled match score for the forward reference is higher than the scaled match score for the backward reference, then step 614 is performed and the match corresponding to the business event, with both forward and backward references, is stored as a forward reference. However, if the scaled match score for the backward reference is higher than the scaled match score for the forward reference, then step 616 is performed, at which the match corresponding to the business event with both forward and backward references is stored as a backward reference.

Further, in one embodiment of the present invention, the contribution from the matches is calculated as the average of the scaled match score values. Mathematically, it can be expressed as:

MATCH_AVG=Σ(1−mᵢ)/n

where:

i=1, 2, 3, . . . n; and

‘n’ is the total number of matches found in the text contained in the web page.

The contribution of the orphan events to the confidence rating of the web page is represented mathematically as:

ORPHAN_SCORE=min [(1−mᵢ)]×A/(A+n)

where:

min [(1−mᵢ)] is the minimum of the scaled match score values for all the matches

found in the text contained in the selected web page; and

‘A’ is the number of orphan events found in the text contained in the selected web page.

The confidence rating for the selected web page is given as a sum of MATCH_AVG and ORPHAN_SCORE. Mathematically, it can be represented as:

CONFIDENCE_RATING=MATCH_AVG+ORPHAN_SCORE

In this embodiment, a higher confidence rating of a web page is indicative of a relatively large number of strong matches as compared to a web page with a lower confidence rating.

Hence, business events are matched to company names identified in the text contained in the selected document as shown at step 326 of FIG. 3B. Finally, when all the evaluated web pages have been processed, the resulting matched company names and business events are passed to the output device at step 328. In this manner, company names and business events are identified in the text contained in the web pages on the World Wide Web and matched to generate company-business event pairs.

The system, as described in the present invention or any of its components may be embodied in the form of a processing machine. Typical examples of a processing machine include a general purpose computer, a programmed microprocessor, a micro-controller, a peripheral integrated circuit element, and other devices or arrangements of devices, which are capable of implementing the steps that constitute the method of the present invention.

The processing machine executes a set of instructions that are stored in one or more storage elements, in order to process input data. The storage elements may also hold data or other information as desired. The storage element may be in the form of a database or a physical memory element present in the processing machine.

The set of instructions may include various instructions that instruct the processing machine to perform specific tasks such as the steps that constitute the method of the present invention. The set of instructions may be in the form of a program or software. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine.

It is not necessary that the various processing machines and/or storage elements be physically located in the same geographical location. The processing machines and/or storage elements may be located in geographically distinct locations and connected to each other to enable communication. Various communication technologies may be used to enable communication between the processing machines and/or storage elements. Such technologies include connection of the processing machines and/or storage elements in the form of a network. The network can be an intranet, an extranet, the Internet or any client server models that enable communication. Such communication technologies may use various protocols such as TCP/IP, UDP, ATM or OSI.

In the system and method of the present invention, a variety of “user interfaces” may be utilized to allow a user to interface with the processing machine or machines that are used to implement the present invention. The user interface is used by the processing machine to interact with a user in order to convey or receive information. The user interface could be any hardware, software, or a combination of hardware and software used by the processing machine that allows a user to interact with the processing machine. The user interface may be in the form of a dialogue screen and may include various associated devices to enable communication between a user and a processing machine. It is contemplated that the user interface might interact with another processing machine rather than a human user. Further, it is also contemplated that the user interface may interact partially with other processing machines while also interacting partially with the human user.

The present invention provides the advantage of achieving the objective of automatically identifying and matching company names to business events occurring in a text, without the need for any manual intervention. The present invention provides a method that can automatically perform the steps of identifying occurrences of company names and business events in a text and subsequently matching the identified company names to the identified business events.

However, the present invention is not just limited to the embodiments described above. The present invention can be used to identify and match company names to business events occurring in textual form in any format of electronic documents. Further, these documents may be present in a local database or they may be present on a network. The network may be a Local Area Network (LAN), a Wide Area Network (WAN) or the World Wide Web (WWW).

In another alternative embodiment, an information quality score can be assigned to documents instead of the information quantity score. The information quantity score of a document is a measure of the potential amount of business event information that may be contained in a document. The information quality score of a document is based on the amount of directly relevant information that is contained in the document. Directly relevant information is that part of the business event information contained in a document, which relates only to business events specified by the pre-defined set of event phrases.

In yet another alternative embodiment, a pre-supplied database of company names can be used to augment the identification of occurrences of company names in a text. The database of company names contains a list of company names and the present invention can use the database to identify company names in the document that would otherwise be missed by the company name search method applied by the present invention.

In yet another embodiment, the present invention can be used to generate output other than company-business event pairs. The present invention can be used to identify information like date, time and other event specific information while identifying business events in the text. This information can then be linked to associated events in order to generate output in the form of sets like <company, business event, event specific details>.

While the various embodiments of the present invention have been illustrated and described, it will be clear that the present invention is not limited to these embodiments only. Numerous modifications, changes, variations, substitutions and equivalents will be apparent to those skilled in the art without departing from the spirit and scope of the present invention as described in the claims.

What is claimed is:

1. A system for identifying and matching company names and business events occurring in a document, the system comprising:
a. a crawler for downloading documents;
b. a parser for parsing the downloaded documents;
c. an evaluator for evaluating the parsed documents to select documents on the basis of an information quantity score, the information quantity score being a measure of amount of relevant information contained in each of the parsed documents; and
d. an information extractor for identifying and matching business events to company names, the business events and company names being present in the selected documents.

2. The system of claim 1 wherein the crawler downloads documents identified by a pre-defined first set of links.

3. The system of claim 1 wherein the parser for parsing the downloaded documents breaks down the downloaded documents into components, the components comprising at least one of free text, titles and a second set of links to other documents.

4. The system of claim 1 wherein for each of the documents the amount of relevant information corresponds to a text portion of the document, and wherein the score corresponds to a ratio of the amount of relevant information to a size of the document.

5. The system of claim 1 wherein the information extractor further identifies co-references of the company names occurring in the text contained in the selected documents, the co-references being substitutes that are used to refer to company names in different parts of the text in the selected document.

6. The system of claim 1 wherein the information extractor further computes a match score for each of the matches found in each of the selected documents on the basis of a distance between a company name and a business event that constitute a match in the selected document.

7. The system of claim 1 wherein the information extractor further generates a confidence rating for each of the selected documents, the confidence rating being based on contributions from the matches between business events and company names and the contribution from the orphan events in the selected document.

8. A method for identifying and matching company names and business events, the method comprising the steps of:
a. crawling a first set of links on a network to download documents;
b. parsing the downloaded documents;
c. evaluating the parsed documents to select documents on the basis of an information quantity score, the information quantity score being a measure of amount of relevant information contained in the document; and
d. processing the selected documents to generate company-event pairs from information present in text contained in the document.

9. The method of claim 8 wherein the step of crawling a first set of links comprises the steps of:
a. identifying the first set of links, the links being references to locations of documents on the network; and
b. downloading the documents available at the locations on the network referenced by the first set of links.

10. The method of claim 8 wherein the step of parsing the downloaded documents comprises the steps of:
a. breaking down the documents into individual components, the components comprising at least one of free text, titles and a second set of links to other documents on the network; and
b. adding the second set of links to the first set of links used for crawling.

11. The method of claim 8 wherein the step of evaluating the parsed documents further comprises the steps of:
a. assigning an information quantity score to each of the parsed documents on the basis of amount of relevant information contained in the parsed documents; and
b. selecting the documents on the basis of the information quantity score assigned to the parsed documents.

12. The method of claim 11 wherein the information quantity score of the parsed document is computed as a ratio of free text contained in the document to a size of the document.

13. The method of claim 8 wherein the step of processing the selected documents to generate company-event pairs further comprises the steps of:
a. identifying the occurrences of company names and their co-references in each of the selected documents, the co-references being substitutes that are used to refer to company names in different parts of the text;
b. identifying the occurrences of business events in each of the selected documents; and
c. matching the identified business events to the identified company names in each of the selected documents.

14. The method of claim 8 wherein the step of processing the selected documents to generate company-event pairs further comprises computing a match score for each match between an identified company name and an identified business event, the match score being calculated on the basis of a distance between the identified company name and the identified business event in the document.

15. The method of claim 8 wherein the step of processing the selected documents to generate company-event pairs further comprises generating a confidence rating for each of the selected documents, wherein the confidence rating is calculated on the basis of contribution from matches between business events and company names and contribution from orphan events within each of the selected documents, the orphan events being business events that are not associated with any company name in the selected document.

16. A computer program product comprising a computer usable medium having a computer readable program code embodied therein for identifying and matching company names and business events, the computer program code performing the steps of:
a. crawling a pre-defined first set of links to download documents referenced by the pre-defined first set of links;
b. parsing the downloaded documents;
c. evaluating the parsed documents to select documents on the basis of an information quantity score, the information quantity score being a measure of amount of relevant information contained in the document;
d. identifying company names and business events in the text contained in each of the selected documents; and
e. matching the identified business events to the identified company names for each of the selected documents.

17. A system for identifying and matching company names and business events, the system comprising:
a. a crawler for downloading documents, the documents being referenced by links present in a pre-defined first set of links;
b. a parser for parsing the downloaded documents to break the downloaded documents into components including at least one of free text, title and a second set of links;
c. an evaluator for evaluating the parsed documents to select documents on the basis of an information quantity score, the information quantity score being a measure of amount of relevant information contained in the documents; and
d. an information extractor for identifying and matching business events to company names, the business events and company names being present in the text contained in the selected documents; wherein the information extractor comprises:
i. a company name extractor for identifying company names in the text contained in the selected documents;
ii. a business event extractor for identifying business events in the text contained in the selected documents; and
iii. an entity-event matcher for matching the identified business events to the identified company names for each of the selected documents and computing a match score for each of the matches in each of the selected documents.
iv. a confidence rating generator for generating a confidence rating for each of the selected documents.

18. The system of claim 17 wherein the entity-event matcher computes a match score for each match between an identified company name and an identified business event in a selected document based on a distance between the identified company name and the identified business event in the selected document.

19. The system of claim 17 wherein the confidence rating generator generates a confidence rating for each of the selected documents, wherein the confidence rating is calculated on the basis of contribution from matches between business events and company names and contribution from orphan events within each of the selected documents, the orphan events being business events that are not associated with any company name in the selected document.

20. A method for identifying and matching company names and business events, the method comprising the steps of:
a. crawling a network to download documents referenced by a pre-defined first set of links;
b. parsing the downloaded documents to break down the downloaded documents into components, the components comprising at least one of free text, titles and a second set of links to other documents;
c. evaluating the parsed documents to select documents on the basis of an information quantity score, the information quantity score being a measure of amount of relevant information contained in the parsed document;
d. identifying the occurrences of business events in text contained in the selected documents;
wherein identifying the occurrences of business events in text contained in the selected documents involves:
i. identifying the business events in the text by locating phrases exactly as they occur in the pre-defined set of phrases; and
ii. identifying the business events by searching the text for variations of the phrases present in the pre-defined set of phrases; and
e. identifying occurrences of company names in text contained in the selected documents;
wherein identifying the occurrences of company names in text contained in the selected documents involves:
i. identifying the occurrences of company names in the text by searching for a set of company name suffix indicators in the text;
ii. applying a pre-defined set of heuristics to identify the company name preceding the identified company name suffix indicator; and
f. matching identified business events to identified company names to generate company-business event pairs;
wherein matching identified business events to identified company names to generate company-business event pairs involves:
i. determining a match between the identified business events and the identified company names for each of the selected documents;
ii. computing a match score for each of the matches in each of the selected documents, the score being based on a distance between the identified company name and the identified business event in the selected document.
iii. calculating a confidence rating for each of the selected documents, wherein the confidence rating is calculated on the basis of contribution from matches between business events and company names and contribution from orphan events within each of the selected documents, the orphan events being business events that are not associated with any company name in the selected document.

21. The method of claim 20, wherein the contribution from matches between business events and company names occurring in a selected document is determined by calculating an average of scaled match score values of all matches in the selected document.

22. The method of claim 20, wherein the contribution from orphan events occurring in a selected document is determined by taking a minimum value among all scaled match scores and multiplying this value with a quotient of the number of orphan events and the total number of orphan events and positive matches occurring in the selected document, the positive matches being matches that have a forward reference or a backward reference associated with them.
